(19) United States
(12) Patent Application Publication
(10) Pub. No.: US 2026/0194433 A1
(43) Pub. Date: Jul. 9, 2026

(54) MATERIAL TESTING SYSTEM

(71) Applicant: National Technology & Engineering Solutions of Sandia, LLC, Albuquerque, NM (US)

(72) Inventors: Mark Foster, Albuquerque, NM (US); Sharlotte Kramer, Albuquerque, NM (US)

(21) Appl. No.: 19/014,997

(22) Filed: Jan. 9, 2025

(51) Int. Cl. G01N 3/56; G01N 3/04

(52) U.S. Cl. CPC G01N 3/56; G01N 3/04; G01N 2203/0026; G01N 2203/0048; G01N 2203/0254

(57) ABSTRACT

A material testing system and methods of testing an interaction between two materials are presented. A material testing system comprises a vertical actuator configured to repeatedly move in a vertical direction; and a pair of horizontal actuators configured to apply forces normal to movement of the vertical actuator.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The disclosure relates generally to testing material properties, and more specifically to measuring friction.

### 2. Description of the Related Art

Current friction measuring systems are limited in the pressures and contact area that can be tested. Therefore, it would be desirable to have a method and apparatus that take into account at least some of the issues discussed above, as well as other possible issues.

### SUMMARY

An illustrative embodiment provides a material testing system. The material testing system comprises a vertical actuator configured to repeatedly move in a vertical direction, and a pair of horizontal actuators configured to apply forces normal to movement of the vertical actuator.

Another illustrative embodiment provides a method of testing an interaction between two materials. Material samples of a first material are pressed against opposing surfaces of a number of material samples of a second material by a pair of horizontal actuators. The second material is repeatedly moved in a vertical direction normal to forces of the horizontal actuators while the first material is in contact with the second material.

Yet another illustrative embodiment provides a method of testing an interaction between two materials. Material samples of a first material are secured to a pair of horizontal actuators. A number of material samples of a second material is secured to a vertical actuator. The material samples of the first material are pressed against opposing surfaces of the number of material samples of the second material by the pair of horizontal actuators. The second material is repeatedly moved in a vertical direction while the first material is in contact with the second material.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a testing environment in accordance with an illustrative embodiment;

FIG. 2 is an illustration of a material testing system in accordance with an illustrative embodiment;

FIG. 3 is an illustration of a material testing system in accordance with an illustrative embodiment;

FIG. 4 is an illustration of a material testing system in accordance with an illustrative embodiment;

FIG. 5 is a flowchart for testing an interaction between two materials in accordance with an illustrative embodiment; and

FIG. 6 is a flowchart for testing an interaction between two materials in accordance with an illustrative embodiment.

### DETAILED DESCRIPTION

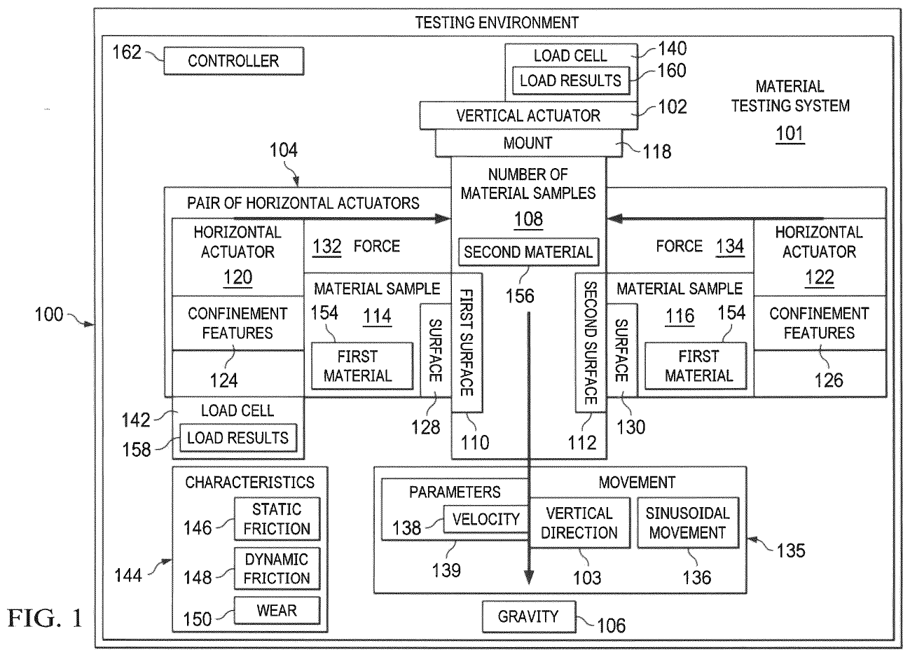

Turning now to FIG. 1, an illustration of a block diagram of a testing environment is depicted in accordance with an illustrative embodiment. Material testing system 101 is present in testing environment 100. Material testing system 101 can be used to determine characteristics 144 from interactions between first material 154 and second material 156.

Material testing system 101 can be used to test material samples having a variety of sizes or shapes. In some illustrative examples, material testing system 101 can be used to test full parts that were used in production. In some illustrative examples, material testing system 101 can be used to test portions of parts that were previously used in production. Material testing system 101 can be used to test material interactions between two different materials. Material testing system 101 can be used to test material interactions between first material 154 attached to pair of horizontal actuators 104 and second material 156 attached to vertical actuator 102.

Material testing system 101 comprises vertical actuator 102 configured to repeatedly move in vertical direction 103 and pair of horizontal actuators 104 configured to apply forces, force 132 and force 134, normal to movement of vertical actuator 102. In some illustrative examples, vertical direction 103 can be described as parallel to gravity 106. In some illustrative examples, force 132 and force 134 can be described as normal to gravity 106.

Horizontal actuator 120, horizontal actuator 122, and vertical actuator 102 comprise any desirable type of actuator. In some illustrative examples, vertical actuator 102 and pair of horizontal actuators 104 comprise hydraulic actuators. In some illustrative examples, at least one of horizontal actuator 120, horizontal actuator 122, or vertical actuator 102 comprises one of an electric actuator, an electromagnetic actuator, or a mechanical actuator.

Pair of horizontal actuators 104 comprises horizontal actuator 120 and horizontal actuator 122. Pair of horizontal actuators 104 are configured to apply equal and opposite forces, force 132 and force 134. Confinement features on pair of horizontal actuators 104 are configured to retain material samples. Horizontal actuator 120 comprises confinement features 124 configured to retain a material sample, such as material sample 114. Horizontal actuator 122 comprises confinement features 126 configured to retain a material sample, such as material sample 116.

In some illustrative examples, the confinement features, at least one of confinement features 124 or confinement features 126, comprise shims. In some illustrative examples, the confinement features, at least one of confinement features 124 or confinement features 126, comprise at least one of fasteners, clamps, or clips configured to secure complete parts to pair of horizontal actuators 104.

To test interface characteristics between first material 154 and second material 156, material sample 114 and material sample 116 of first material 154 are secured to pair of horizontal actuators 104. Material sample 114 is secured to horizontal actuator 120 so that surface 128 of material sample 114 is parallel to vertical direction 103 of movement 135. In some illustrative examples, movement 135 is a repeated movement. In these illustrative examples, parameters 139 of movement 135 include a quantity of cycles. Surface 128 can also be referred to as a contact surface. Material sample 116 is secured to horizontal actuator 122 so that surface 130 of material sample 116 is parallel to vertical direction 103 of movement 135. Surface 130 can also be referred to as a contact surface.

A number of material samples 108 of second material 156 is secured to vertical actuator 102 by mount 118. Mount 118 can take any desirable form. In some illustrative examples, mount 118 comprises a screw or other fastener directly fastened into the number of material samples 108. In other illustrative examples, mount 118 comprises clamps, clips, or other mounting hardware configured to secure the number of material samples 108. In some illustrative examples, the number of material samples 108 comprises cut samples. In some illustrative examples, the number of material samples 108 comprises complete parts. In some illustrative examples, mount 118 is configured to secure a complete part.

The number of material samples 108 is secured to vertical actuator 102 such that first surface 110 and second surface 112 are parallel to vertical direction 103 of movement 135. First surface 110 and second surface 112 can be referred to as contact surfaces. Material sample 114 is secured to horizontal actuator 120 so that surface 128 of material sample 114 is parallel to first surface 110 of the number of material samples 108. Material sample 116 is secured to horizontal actuator 122 so that surface 130 of material sample 116 is parallel to second surface 112 of the number of material samples 108. The number of material samples 108 is secured such that first surface 110 and second surface 112 are parallel to surface 128 and surface 130.

A load cell is connected to one horizontal actuator of pair of horizontal actuators 104. As depicted, load cell 142 is connected to horizontal actuator 120 of pair of horizontal actuators 104. In some illustrative examples, load cell 142 can be referred to as a horizontal load cell. As depicted load cell 140 is connected to vertical actuator 102. In some illustrative examples, load cell 140 can be referred to as a vertical load cell.

Data from load cell 140 and load cell 142 can be used to determine interface characteristics. Load cell 140 generates load results 160 and load cell 142 generates load results 158. In some illustrative examples, data from at least one of load cell 140 or load cell 142 can be used for setting up material testing system 101. In some illustrative examples, pair of horizontal actuators 104 is adjusted prior to testing based on feedback from load cell 140 to reduce the feedback. In some illustrative examples, the position and initial contact of pair of horizontal actuators 104 are adjusted based on feedback from load cell 140. In some illustrative examples, the position and initial contact of pair of horizontal actuators 104 are adjusted so that the three axes are aligned desirably and not bending the vertical axis. In some illustrative examples, after adjusting the position and initial contact of pair of horizontal actuators 104, control is switched over to constant load.

Controller 162 in material testing system 101 is configured to direct movement of vertical actuator 102. Controller 162 can direct movement of vertical actuator 102 in at any desirable velocity 138 or displacement. In some illustrative examples, controller 162 is configured to direct vertical actuator 102 to move repetitively. In these illustrative examples, controller 162 is configured to repeatedly move vertical actuator 102 for any desirable quantity of cycles. In some illustrative examples, controller 162 is configured to direct movement of vertical actuator 102 in sinusoidal movement 136.

In some illustrative examples, the same controller applies the constant force on the horizontal actuators. In some illustrative examples, controller 162 is configured to direct application of force 132 by horizontal actuator 120 and application of force 134 by horizontal actuator 122. In other illustrative examples, at least one additional controller can be present to direct at least one of application of force 132 by horizontal actuator 120 or application of force 134 by horizontal actuator 122.

During testing, two of the three actuators, horizontal actuator 120 and horizontal actuator 122 apply a compressive load on the material combination. Horizontal actuator 120 applies force 132 and horizontal actuator applies force 134. While the compressive load is held constant, the third actuator, vertical actuator 102, moves relative to the other two actuators, horizontal actuator 120 and horizontal actuator 122. Movement 135 of vertical actuator 102 relative horizontal actuator 120 and horizontal actuator 122 can have any desirable parameters. In some illustrative examples, while the compressive load is held constant, vertical actuator 102 moves in a repetitive sinusoid orthogonal to horizontal actuator 120 and horizontal actuator 122. Sinusoidal movement 136 provides a range of velocities to encompass both static and dynamic friction properties in a single test. The reciprocating sinusoid of sinusoidal movement 136 can have any desirable displacement, maximum velocity, and quantity of cycles. In some illustrative examples, the displacement can be approximately +/−½ in displacement. In some illustrative examples, the maximum velocity can be approximately 0.16 in/s maximum velocity.

Performing testing of first material 154 and second material 156 in material testing system 101 can be used to determine at least one characteristic of the interface. Load results 158 from load cell 142 during testing and load results from load cell 140 during testing can be utilized to determine at least one characteristic of characteristics 144. Characteristics 144 comprise static friction 146, dynamic friction 148, and wear 150. In some illustrative examples, characteristics 144 can comprise other interface characteristics.

The friction coefficient is equal to load results 160 from load cell 140 divided by load results 158 from load cell 142. More specifically, the friction coefficient is equal to the vertical load cell signal divided by the horizontal load cell signal. The design of material testing system 101 and movement 135 enables direct measurement of the friction coefficient from load results 160 and load results 158.

Static friction 146 can be determined by the ratio of load results 160 to load results 158 where velocity 138 is at or near zero in sinusoidal movement 136. Dynamic friction 148 is the remaining portion other than static friction 146. Dynamic friction 148 can be determined where the ratio of load results 160 to load results 158 plateaus when velocity 138 is not close to zero.

The number of material samples 108 moves up and down in movement 135. Parameters 139 of movement 135 can be designed to mimic specific use cases. In some illustrative examples, parameters 139 of movement 135 can be varied for repeated testing. For example, first material 154 and second material 156 can undergo multiple tests with different movement 135 parameters 139 for each test. In some illustrative examples, parameters 139 can be changed based on the materials for first material 154 and second material 156. Parameters 139 can also comprise displacement and quantity of cycles. Displacement may also be referred to as stroke length. Force 132 and force 134 can also be adjusted based on at least one of the types of material of first material 154 and second material 156, parameters 139 of movement 135, or to mimic specific use cases.

When movement 135 is sinusoidal movement 136, velocity 138 comprises a range. The range of velocity 138 of sinusoidal movement 136 can be designed to mimic specific use cases. Within a certain range, velocity 138 is constantly variable in sinusoidal movement 136. The displacement is as low as zero or maxes out. When load results 160 are observed over a desired number of cycles it looks like a square wave. Velocity is at or near zero in some portions of sinusoidal movement 136.

In some illustrative examples, the friction coefficient is equal to the vertical load cell signal divided by the horizontal load cell signal. The illustrative examples are configured to measure the friction coefficient directly from the load cell signals. Because sinusoidal movement 136 can have points of zero velocity, the location where friction changes from static to dynamic can be identifiable. Sinusoidal movement 136 enables determination of both static friction 146 and dynamic friction 148 from one test.

With this method and design of material testing system 101, surface area is fairly independent. In some illustrative examples, at least one of material sample 114, material sample 116, or material sample 108 can be cut from a larger material or larger assembly. In some illustrative examples, at least one of material sample 114, material sample 116, or material sample 108 can be an entire component, part, or assembly.

The illustration of testing environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, in non-depicted examples, at least one additional controller can be present to direct at least one of application of force 132 by horizontal actuator 120 or application of force 134 by horizontal actuator 122.

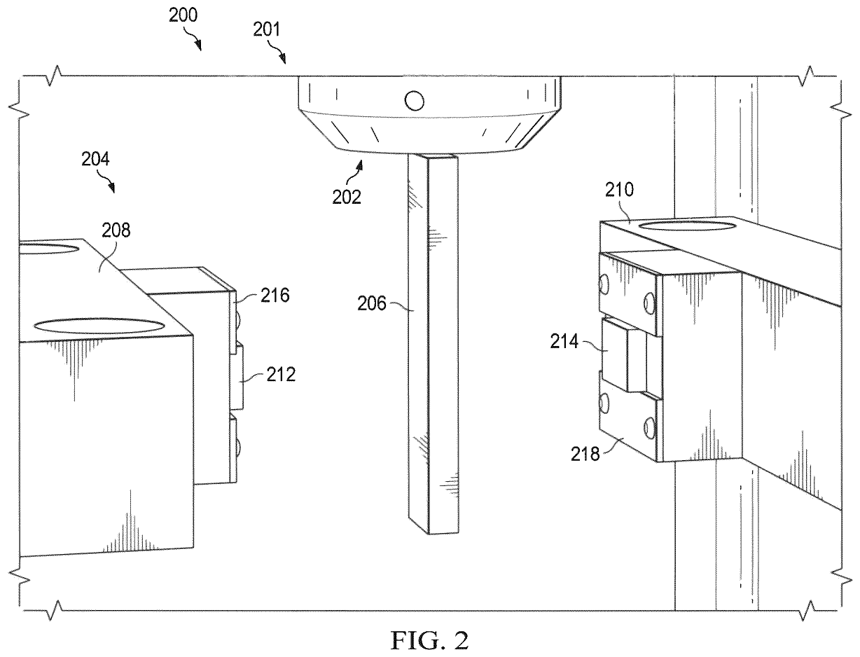

Turning now to FIG. 2, an illustration of a material testing system is depicted in accordance with an illustrative embodiment. Material testing system 201 is a physical implementation of material testing system 101 of FIG. 1. Material testing system 201 comprises vertical actuator 202 configured to repeatedly move in a vertical direction and pair of horizontal actuators 204 configured to apply forces normal to movement of vertical actuator 202.

In this illustrative example, pair of horizontal actuators 204 comprises horizontal actuator 208 and horizontal actuator 210. Material sample 212 is secured to horizontal actuator 208 by confinement features 216. Material sample 214 is secured to horizontal actuator 210 by confinement features 218. Material sample 212 and material sample 214 are samples of the same material. In this illustrative example, confinement features 216 and confinement features 218 comprise shims.

A number of material samples is secured to vertical actuator 202. In this illustrative example, the number of material samples comprises a single material sample, material sample 206. Material sample 206 is secured to vertical actuator 202. Material sample 206 can be secured to vertical actuator 202 in any desirable fashion. In some illustrative examples, a fastener is sent into material sample 206. In other non-depicted illustrative examples, material sample 206 can be clamped or otherwise externally connected to vertical actuator 202.

In view 200, material testing system 201 is in an open state. In view 200, testing is not being conducted using material testing system 201. View 200 may be a view prior to or following testing of material sample 212, material sample 214, and material sample 206.

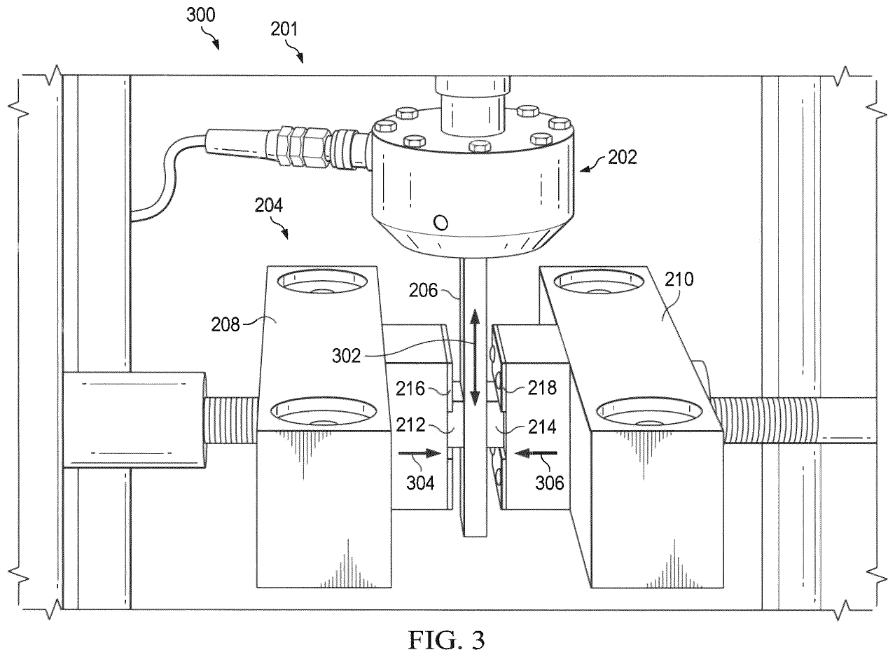

Turning now to FIG. 3, an illustration of a material testing system is depicted in accordance with an illustrative embodiment. View 300 is a view of material testing system 201 during testing of material sample 212, material sample 214, and material sample 206. In view 300 material sample 212 is in contact with a first surface of material sample 206. In view 300 material sample 214 is in contact with a second surface of material sample 206.

In view 300, vertical actuator 202 repeatedly moves in vertical direction 302 and pair of horizontal actuators 204 applies forces, force 304 and force 306, normal to movement of vertical actuator 202. In some illustrative examples, repeatedly moving in vertical direction 302 is a vertical actuation in a reciprocating sinusoid. Sinusoidal movement can enable determining static friction and dynamic friction from a single test.

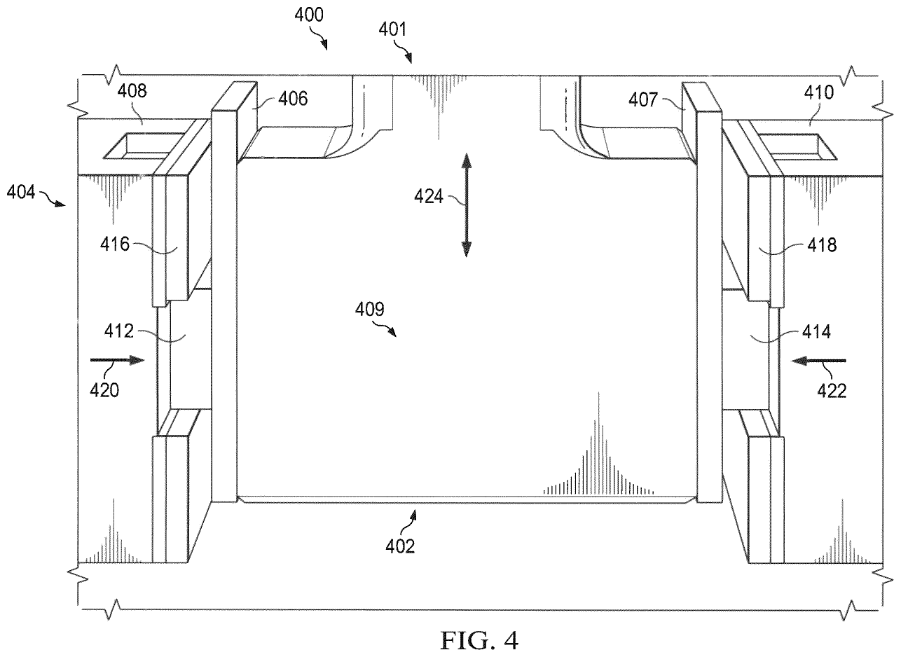

Turning now to FIG. 4, an illustration of a material testing system is depicted in accordance with an illustrative embodiment. View 400 is a view of material testing system 401 during testing of interface characteristics of a first material and a second material. Material testing system 401 is a physical implementation of material testing system 101 of FIG. 1. Material testing system 401 comprises vertical actuator 402 configured to repeatedly move in a vertical direction and pair of horizontal actuators 404 configured to apply forces normal to movement of vertical actuator 402.

In this illustrative example, pair of horizontal actuators 404 comprises horizontal actuator 408 and horizontal actuator 410. Material sample 412 is secured to horizontal actuator 408 by confinement features 416. Material sample 414 is secured to horizontal actuator 410 by confinement features 418. In this illustrative example, confinement features 416 and confinement features 418 comprise shims. Material sample 412 and material sample 414 are samples of the same material.

A number of material samples is secured to vertical actuator 402. The number of material samples can be secured to vertical actuator 402 in any desirable fashion. In this illustrative example, the number of material samples comprises two material samples, material sample 406 and material sample 407. Material sample 406 and material sample 407 comprise a same material. In this illustrative example, material sample 406 and material sample 407 are secured to mount 409 of vertical actuator 402.

View 400 is a view of material testing system 401 during testing of material sample 412, material sample 414, material sample 406, and material sample 407. In view 400 material sample 412 is in contact with a first surface of material sample 406. In view 400 material sample 414 is in contact with a second surface of material sample 407. The first surface of material sample 406 and the second surface of material sample 407 can be referred to as opposing surfaces. The first surface and the second surface are outward facing surfaces of the material secured to vertical actuator 402. The first surface and the second surface are facing the pair of horizontal actuators.

In view 400, vertical actuator 402 repeatedly moves in vertical direction 424 and pair of horizontal actuators 404 applies forces, force 420 and force 422, normal to movement of vertical actuator 402. In some illustrative examples, repeatedly moving in vertical direction 424 is a vertical actuation in a reciprocating sinusoid. Sinusoidal movement can enable determining static friction and dynamic friction from a single test.

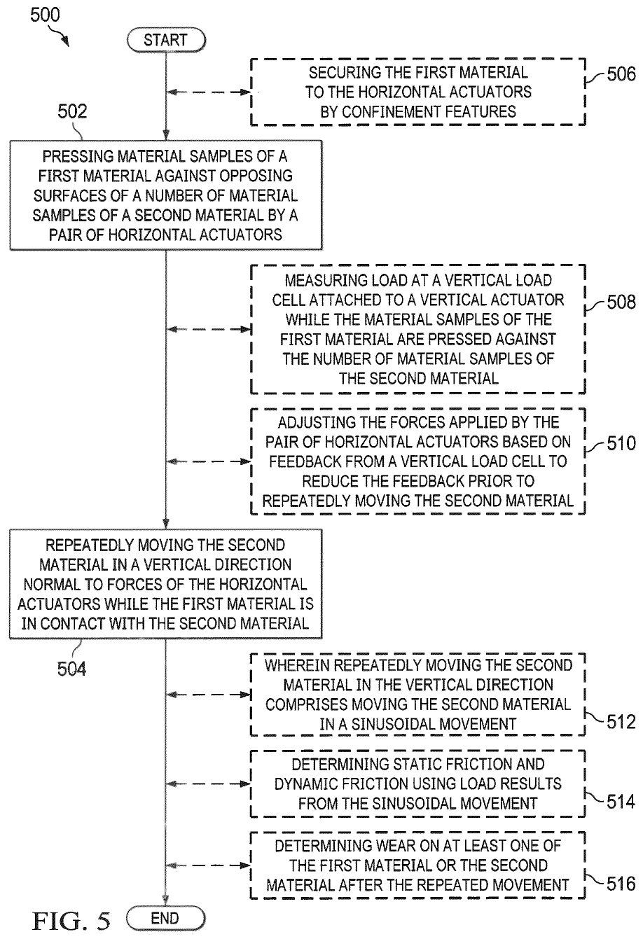

Turning now to FIG. 5, a flowchart for testing an interaction between two materials is depicted in accordance with an illustrative embodiment. Method 500 can be performed using material testing system 101 of FIG. 1. Method 500 can be performed using material testing system 201 of FIGS. 2 and 3. Method 500 can be performed using material testing system 401 of FIG. 4.

Method 500 comprises pressing material samples of a first material against opposing surfaces of a number of material samples of a second material by a pair of horizontal actuators (operation 502). Method 500 comprises repeatedly moving the second material in a vertical direction normal to forces of the horizontal actuators while the first material is in contact with the second material (operation 504). Afterwards, method 500 terminates.

In some illustrative examples, method 500 further comprises securing the first material to the horizontal actuators by confinement features (operation 506). In some illustrative examples, the confinement features comprise shims. In some illustrative examples, the confinement features comprise at least one of fasteners, clamps, or clips configured to secure complete parts to the pair of horizontal actuators.

In some illustrative examples, method 500 further comprises measuring load at a vertical load cell attached to a vertical actuator while the material samples of the first material are pressed against the number of material samples of the second material (operation 508). In some illustrative examples, method 500 further comprises adjusting the forces applied by the pair of horizontal actuators based on feedback from a vertical load cell to reduce the feedback prior to repeatedly moving the second material (operation 510). In some illustrative examples, the position and initial contact of the horizontal actuators are adjusted based on feedback from a vertical load cell. In some illustrative examples, the position and initial contact of the horizontal actuators are adjusted so that the three axes are aligned desirably and not bending the vertical axis. In some illustrative examples, after adjusting the position and initial contact of the horizontal actuators, control is switched over to constant load.

In some illustrative examples, repeatedly moving the second material in the vertical direction comprises moving the second material in a sinusoidal movement (operation 512). In some illustrative examples, the sinusoidal movement can be designed to mimic specific use cases. For example, the velocity range of the sinusoid can be designed or varied to mimic specific use cases.

In some illustrative examples, method 500 further comprises determining static friction and dynamic friction using load results from the sinusoidal movement (operation 514). In some illustrative examples, the friction coefficient is equal to the vertical load cell signal divided by the horizontal load cell signal. The illustrative examples are configured to measure the friction coefficient directly from the load cell signals. Because sinusoidal movement has points of zero velocity, the location where friction changes from static to dynamic can be identifiable. Sinusoidal movement enables determination of both static friction and dynamic friction from one test.

In some illustrative examples, method 500 further comprises determining wear on at least one of the first material or the second material after the repeated movement (operation 516). Although the material testing system does not quantify wear, wear created by the continuous movement in the material testing system can be determined with subsequent analysis. To determine wear, the first material and the second material can be examined pre-testing in the material testing system and post-testing in the material testing system.

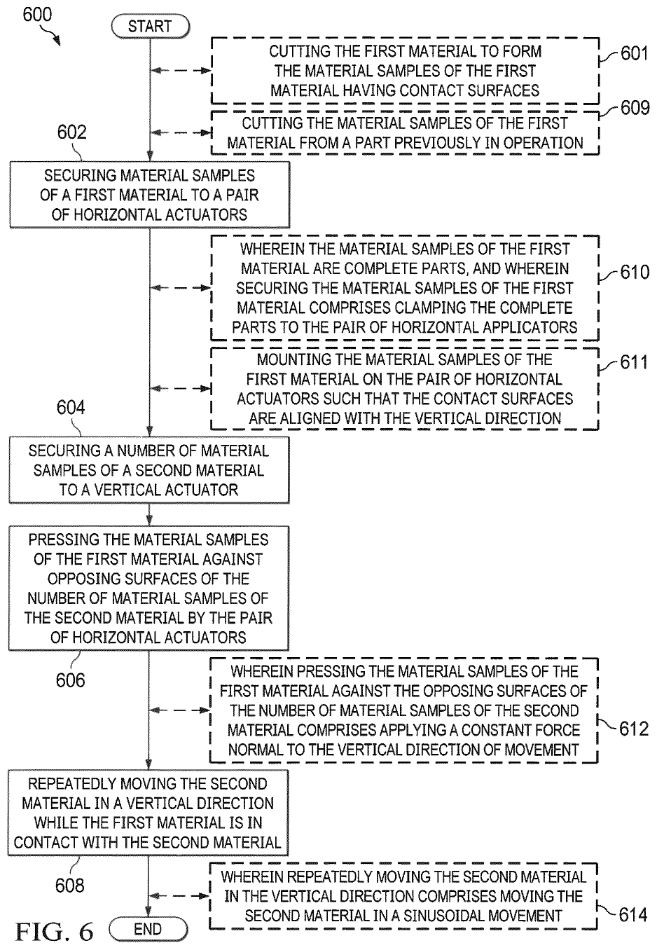

Turning now to FIG. 6, a flowchart for testing an interaction between two materials is depicted in accordance with an illustrative embodiment. Method 600 can be performed using material testing system 101 of FIG. 1. Method 600 can be performed using material testing system 201 of FIGS. 2 and 3. Method 600 can be performed using material testing system 401 of FIG. 4.

Method 600 comprises securing material samples of a first material to a pair of horizontal actuators (operation 602). The material samples are secured such that contact surfaces of the material samples are parallel to the vertical actuation direction for testing.

Method 600 comprises securing a number of material samples of a second material to a vertical actuator (operation 604). The material samples are secured such that contact surfaces of the material samples are parallel to the vertical actuation direction for testing.

Method 600 comprises pressing the material samples of the first material against opposing surfaces of the number of material samples of the second material by the pair of horizontal actuators (operation 606). Method 600 comprises repeatedly moving the second material in a vertical direction while the first material is in contact with the second material (operation 608). Afterwards, method 600 terminates.

In some illustrative examples, method 600 further comprises cutting the first material to form the material samples of the first material having contact surfaces (operation 601). In some illustrative examples, method 600 further comprises cutting the material samples of the first material from a part previously in operation (operation 609). In other illustrative examples, the material samples of the first material can be cut from a virgin material that has not be used previously in operation.

In some illustrative examples, the material samples of the second material are cut from a part previously in operation. In other illustrative examples, the material samples of the second material can be cut from a virgin material that has not be used previously in operation.

In some illustrative examples, the material samples of the first material are complete parts, and securing the material samples of the first material comprises clamping the complete parts to the pair of horizontal actuators (operation 610). In some illustrative examples, method 600 further comprises mounting the material samples of the first material on the pair of horizontal actuators such that the contact surfaces are aligned with the vertical direction (operation 611). In some illustrative examples, mounting the material samples for both the first material and the second material is performed so that the contact surfaces of all material samples are parallel to the vertical actuation. In some illustrative examples, cutting the material samples for both the first material and the second material is performed so that the contact surfaces of the first material and the second material can mate with each other.

In some illustrative examples, pressing the material samples of the first material against the opposing surfaces of the number of material samples of the second material comprises applying a constant force normal to the vertical direction of movement (operation 612). In some illustrative examples, repeatedly moving the second material in the vertical direction comprises moving the second material in a sinusoidal movement (operation 614).

The illustrative examples provide a material testing system with a two axis, three actuator design. The dual interface with a pair of opposing actuators minimizes bending during testing. The connections to the actuators can accommodate various types and shapes of materials.

The illustrative examples provide for testing of dynamic, static, velocity, variable load, fretting, and steady state characteristics. The illustrative examples provide for testing of true interfacial material combinations (not surrogates). The illustrative examples are less application specific than traditional methods.

The material testing system is configured to measure the coefficient of friction of material interfaces. The illustrative examples can use true materials cut from assemblies to show aging, wear, and surface influences. The material testing system comprises three actuators. In some illustrative examples, the material testing system comprises three servo hydraulic actuators. Two of the three actuators apply a compressive load on the material combination. While the compressive load is held constant, the third actuator moves relative to the other two actuators. In some illustrative examples, while the compressive load is held constant, the third actuator moves in a repetitive sinusoid orthogonal to the other two actuators. The sinusoidal movement provides a range of velocities to encompass both static and dynamic friction properties in a single test. The reciprocating sinusoid can have any desirable displacement, maximum velocity, and quantity of cycles. In some illustrative examples, the displacement can be approximately +/−½ in displacement. In some illustrative examples, the maximum velocity can be approximately 0.16 in/s maximum velocity.

The illustrative examples can provide material testing with any desirable quantity of cycles. In some illustrative examples, the testing can comprise ten or more cycles. The test can be run at many velocities, compressive loads, number of cycles, and on many types of materials, from compliant polymers to hardened steels.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 506 through operation 516 may be optional. As another example, operation 601 and operations 609 through operation 614 may be optional.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A material testing system comprising:
a vertical actuator configured to repeatedly move in a vertical direction; and
a pair of horizontal actuators configured to apply forces normal to movement of the vertical actuator.

2. The material testing system of claim 1 further comprising:
a load cell connected to one horizontal actuator of the pair of horizontal actuators.

3. The material testing system of claim 1 further comprising:
a load cell connected to the vertical actuator.

4. The material testing system of claim 1 further comprising:
a controller configured to direct movement of the vertical actuator in a sinusoidal movement.

5. The material testing system of claim 1 further comprising:
confinement features on the pair of horizontal actuators configured to retain material samples.

6. The material testing system of claim 5, wherein the confinement features comprise shims.

7. The material testing system of claim 5, wherein the confinement features comprise at least one of fasteners, clamps, or clips configured to secure complete parts to the pair of horizontal actuators.

8. The material testing system of claim 1, wherein the vertical actuator and the pair of horizontal actuators comprise hydraulic actuators.

9. A method of testing an interaction between two materials comprising:
pressing material samples of a first material against opposing surfaces of a number of material samples of a second material by a pair of horizontal actuators; and
repeatedly moving the second material in a vertical direction normal to forces of the horizontal actuators while the first material is in contact with the second material.

10. The method of claim 9, wherein repeatedly moving the second material in the vertical direction comprises moving the second material in a sinusoidal movement.

11. The method of claim 10, further comprising:
determining static friction and dynamic friction using load results from the sinusoidal movement.

12. The method of claim 9 further comprising:
determining wear on at least one of the first material or the second material after the repeated movement.

13. The method of claim 9 further comprising:
securing the first material to the horizontal actuators by confinement features.

14. The method of claim 9 further comprising:
adjusting the forces applied by the pair of horizontal actuators based on feedback from a vertical load cell to reduce the feedback prior to repeatedly moving the second material.

15. A method of testing an interaction between two materials comprising:
securing material samples of a first material to a pair of horizontal actuators;
securing a number of material samples of a second material to a vertical actuator;
pressing the material samples of the first material against opposing surfaces of the number of material samples of the second material by the pair of horizontal actuators; and
repeatedly moving the second material in a vertical direction while the first material is in contact with the second material.

16. The method of claim 15, wherein repeatedly moving the second material in the vertical direction comprises moving the second material in a sinusoidal movement.

17. The method of claim 15, wherein pressing the material samples of the first material against the opposing surfaces of the number of material samples of the second material comprises applying a constant force normal to the vertical direction of movement.

18. The method of claim 15, wherein the material samples of the first material are complete parts, and wherein securing the material samples of the first material comprises clamping the complete parts to the pair of horizontal actuators.

19. The method of claim 15 further comprising:
cutting the material samples of the first material from a part previously in operation.

20. The method of claim 15 further comprising:
cutting the first material to form the material samples of the first material having contact surfaces; and
mounting the material samples of the first material on the pair of horizontal actuators such that the contact surfaces are aligned with the vertical direction.
